(19) United States
(12) Patent Application Publication
(10) Pub. No.: US 2026/0302712 A1
(43) Pub. Date: Oct. 1, 2026

(54) CAVITY-ASSISTED PUMP RECYLCING FOR HGH-EFFICIENCY CLADDING-PUMPED DOPED FIBER AMPLIFIERS

(71) Applicant: NOKIA SOLUTIONS AND NETWORKS OY, Espoo (FI)

(72) Inventor: Haoshuo CHEN, Aberdeen, NJ (US)

(21) Appl. No.: 19/097,007

(22) Filed: Apr. 1, 2025

(51) Int. Cl. H01S 3/094; H01S 3/067; H01S 3/0941

(52) U.S. Cl. CPC H01S 3/094015; H01S 3/06716; H01S 3/06733; H01S 3/094007; H01S 3/0941

(57) ABSTRACT

An amplifier for amplifying signals in a multi-core doped fiber having a plurality of cores encapsulated by a cladding, an input end and an output end. The amplifier includes a pump, which may be single-mode or multi-mode, coupled with the input end of the fiber to generate a pump light having a first modal composition. A first reflector is positioned at the output end to reflect pump light back onto the fiber as reflected pump light having a second modal composition. A filter is positioned at the input end to alter the reflected pump light into a third modal composition. At least one second reflector is positioned at the input end and adapted to reinject the altered pump light back into the fiber at the input end.

Various exemplary embodiments disclosed herein relate to optical amplifiers for space division multiplexing in optical fiber networks, and in particular to cavity-assisted pump recycling systems and methods to increase pump utilization efficiency in cladding-pumped multi-core doped fibers.

### BACKGROUND

Space division multiplexing (SDM) significantly enhances the capacity of optical fiber networks by transmitting multiple data streams simultaneously through separate spatial channels, such as through parallel cores of a multi-core fiber (MCF). Two-core MCF cables have already been commercialized in subsea applications. [1].

Optical fiber networks can employ optical amplifiers to boost the strength of light signals in the fiber for circumstances where signals weaken. With multiple core fibers, a typical amplifier arrangement may utilize multiple single-mode amplifiers, one for each core, which will increase cost and decrease energy efficiency.

Multiple single-mode amplifiers can be replaced by a single SDM optical amplifier to attempt to increase both cost and energy efficiency through component sharing and integration across multiple spatial channels. For example, cladding-pumped amplifiers can leverage a single pump diode to amplify all spatial channels/cores within a MCF.

The pump conversion efficiency (η) of cladding-pumped optical amplifiers, however, remains lower than that of conventional ones. See [2-10]. Cladding-pumped multi-core optical amplifiers are inefficient because the overlap between the pump light and the signal is limited as the pump is confined within the large cladding region and is not effectively absorbed by ions within the individual cores.

To address this challenge, various pump recycling techniques and fiber design schemes have been proposed. Despite these efforts, achieving high amplifier efficiency, particularly in configurations with fewer cores or low core density, remains an unresolved issue.

### SUMMARY OF THE INVENTION

The present invention solves problems with and provides advantages over the prior art by providing cavity-assisted pump recycling. According to embodiments of the invention, systems and methods for cavity-assisted pump recycling are particularly applicable to doped fiber amplifiers, and in particular, to cladding-pumped multi-core (MC) erbium-doped fiber amplifiers (EDFAs).

According to embodiments of the present invention, a multi-mode pump diode (MMPD) can be directly coupled with the inner cladding of a double-clad doped fiber. According to embodiments of the present invention, the fiber may be erbium-doped.

According to embodiments of the present invention, pumping light can be recycled by providing reflectors at the input of the fiber and the output of the fiber.

According to embodiments of the present invention, reverse pump light reflected back into the EDF can be conditioned by polarization filtering and spatial filtering.

According to embodiments of the present invention, an amplifier for amplifying signals in a multi-core doped fiber is provided. The multi-core doped fiber has a plurality of cores encapsulated by a cladding, an input end and an output end. A pump diode is coupled with the input end of the fiber and adapted to generate a pump light having a first modal composition. A first reflector is positioned at the output end and adapted to reflect pump light back onto the fiber as reflected pump light having a second modal composition. A filter is positioned at the input end and adapted to alter the reflected pump light into a third modal composition. At least one second reflector positioned fiber at the input end is adapted to reinject the altered pump light back into the fiber at the input end.

According to embodiments of the present invention, the first modal composition represents a thin line of light in a transverse plane. A transverse plane is a plane that is transverse (i.e. perpendicular) to the direction of propagation of the light.

According to embodiments of the present invention, the first modal composition is single pole light and the second modal composition is multi-pole light.

According to embodiments of the present invention, the first modal composition is a few-mode light and the second modal composition is hundred-mode or higher light.

According to embodiments of the present invention, the first modal composition is small-aperture light and the second modal composition is big-aperture light.

According to embodiments of the present invention, an aperture is positioned at the input end between the diode and the fiber, adapted to pass pump light from the diode into the fiber.

According to embodiments of the present invention, the diode is a multi-modal pump diode.

According to embodiments of the present invention, the filter includes a polarizing beam splitter adapted to split the reflected pump light into at least two directions, and the at least one second reflector is adapted to reflect the light in the at least two directions is reflected back into the fiber.

According to embodiments of the present invention, the amplifier is adapted to inject the pump light into both the cores and the cladding of the fiber.

According to embodiments of the present invention, a polarization beam splitter is positioned between the diode and the input end of said fiber and adapted to allow transmission of the TE modes of the pump light into the cores and cladding of the fiber and for splitting the reflected pump light having a second modal composition into X-polarized light and Y-polarized light; and at least one second reflector includes a first mirror for reflecting the X-polarized light and a second mirror for reflecting the Y-polarized light.

According to embodiments of the present invention, an apertured mirror having a narrow pass-through slot is adapted to allow the TE modes of the pump light from the diode to pass through the slot into the cladding and cores of the fiber and for reflecting X-polarized backward-propagating pump light into the cladding.

According to embodiments of the present invention, first and second selective wavelength reflectors combining signal light with pump light at the input end and separate the signal light from pump light at the output end, respectively.

According to embodiments of the present invention, a pump power within the fiber is amplified by at least a factor of at least 3.

According to embodiments of the present invention, a pump power within the fiber is amplified by at least a factor of at least 10.

According to embodiments of the present invention, a method for amplifying signals in a multi-core doped fiber is provided. The multi-core doped fiber has a plurality of cores encapsulated by a cladding, an input end and an output end. The method includes injecting pump light having a first modal composition into the input end of the fiber; reflecting the pump light at the output end back onto the fiber as reflected pump light having a second modal composition; filtering the reflected pump light at the input end to have a third modal composition; and reinjecting the reshaped pump light back into the fiber at the input end.

According to embodiments of the present invention, the first modal composition is a thin line in a transverse plane.

According to embodiments of the present invention, the first modal composition is single pole light and the second modal composition is multi-pole light.

According to embodiments of the present invention, the first modal composition is a few-mode light and the second modal composition is hundred-mode or higher light.

According to embodiments of the present invention, the first modal composition is small-aperture light and the second modal composition is big-aperture light.

According to embodiments of the present invention, the injecting step includes filtering the pump light with an aperture and/or a polarization beam splitter.

According to embodiments of the present invention, the injecting step includes generating the pump light with multi-modal pump diode.

According to embodiments of the present invention, the filtering step includes splitting the reflected pump light with a polarizing beam splitter into at least two directions, and light in the at least two directions is reflected back into the fiber.

According to embodiments of the present invention, the injecting step injects the pump light into both the cores and the cladding of the fiber.

According to embodiments of the present invention, the injecting step includes using a polarization beam splitter to transmit the TE modes of the pump light into the cores and cladding of the fiber and said reinjecting step includes reinjecting Y-polarized reflected pump light into the cores and cladding of the fiber.

According to embodiments of the present invention, the injecting step includes using an apertured mirror having a narrow pass-through slot to allow the TE modes of the pump light from the MMPD to pass through the slot into the cladding while reflecting X-polarized backward-propagating pump light into the cladding.

According to embodiments of the present invention, signal light is combined with the pump light at the input end and separated from the pump light at the output end.

According to embodiments of the present invention, a pump power within the fiber is amplified by at least a factor of at least 3.

According to embodiments of the present invention, a pump power within the fiber is amplified by at least a factor of at least 10.

According to embodiments of the present invention, more than threefold improvement in pump conversion efficiency η can be achieved for both 4-core and 7-core EDFAs.

### BRIEF DESCRIPTION OF DRAWINGS

Embodiments of the present invention are illustrated by way of example with reference to the accompanying drawings Figures (Figs. or FIGS.), which should not be construed to limit the present disclosure.

FIG. 1(a) is a high-level diagram of a cavity-assisted pump recycling scheme using efficient reflectors at both ends to reinject unused pump back to the inner cladding of the double-clad EDF according to embodiments of the present invention.

FIG. 1(b) is a diagram illustrating pump delivery schemes for cladding pumped MC EDFA according to embodiments of the present invention.

FIG. 1(c) includes two images illustrating the modal composition of input pump light and recycled pump light.

FIG. 1(d) is a graph illustrating pump power enhancement p^{enh}ₚᵤₘₚ as a function of reinjection efficiencies at both EDF input (RIin) and output (RIout) according to embodiments of the present invention.

FIG. 2(a) is a schematic diagram of a cladding-pumped MC EDF using the cavity-assisted pump recycling scheme according to embodiments of the present invention.

FIG. 2(b) shows an alternative embodiment for the input end of the amplifier using a polarization beam splitter according to embodiments of the present invention.

FIG. 2(c) shows an alternative embodiment for the input end of the amplifier using an apertured mirror according to embodiments of the present invention.

FIG. 2(d) shows an alternative embodiment for the input end of the amplifier using a mode filter according to embodiments of the present invention.

FIG. 3(a) is an image of experiment setup for pump (re)injection at input end according to embodiments of the present invention.

FIG. 3(b) is a cross-section image of a 4-core EDF.

FIG. 3(c) is a cross-section image of a 7-core EDF.

FIG. 3(d) is a graph of measured pump coupling efficiency between a MMPD and a double-clad MC EDF with an inner cladding diameter of 90 μm according to embodiments of the present invention.

FIG. 3(e) are images for forward-propagation pump light from the MMPD and backward-propagation pump light from the EDF at the apertured mirror, which consists of two D-shaped mirrors, from experimentation.

FIG. 3(f) is a block diagram of an experiment setup for measuring (g) gain and NF.

FIG. 3(g) is a block diagram of an experiment setup for measuring DL.

FIG. 3(h) is an image of an apertured mirror according to embodiments of the present invention.

FIG. 4(a) is a graph showing measured gain, NF and MDL for the 4-core EDFA under the pump power.

FIG. 4(b) is a graph showing measured gain, NF and MDL for the 7-core EDFA under the pump power.

FIG. 4(c) is a graph showing achieved power conversion efficiency η versus the ratio of core-to-cladding area, compared to conventional results.

### DETAILED DESCRIPTION

The following descriptions are presented to enable any person skilled in the art to create and use apparatuses, systems and methods described herein. It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

According to embodiments of the invention, an amplifier and methods of amplifying signal power in a multi-core doped fiber include systems and methods for cavity-assisted pump recycling.

Multi-mode pump diodes (MMPDs) can deliver higher output power and can also exhibit greater electrical-to-optical efficiency compared to single-mode pump diodes applied in conventional core-pumped single-mode EDFAs. The pump conversion efficiency (η) of cladding-pumped MC EDFAs, however, has remained lower than that of conventional EDFAs. Cladding-pumped multi-core MC EDFAs have been inefficient because the overlap between the pump light and the signal is limited as the pump is confined within the large cladding region and is not effectively absorbed by the erbium ions in the individual cores.

According to embodiments of the present invention, cavity-assisted pump recycling reinjects unused pump power back into the core and cladding of the fiber, thereby enhancing pump density in a cladding-pumped MC EDFAs.

According to embodiments of the invention, increased power conversion efficiencies for both 4-core and 7-core EDFAs may be achieved, potentially attaining efficiency levels comparable to single-mode EDFAs, even for cladding-pumped MC EDFAs with minimal core-to-cladding overlap.

According to embodiments, systems and methods may be compatible with multimode EDFs and multi-mode MC EDFs therefore can be regarded as a universal pump recycling solution for cladding pumped SDM EDFAs.

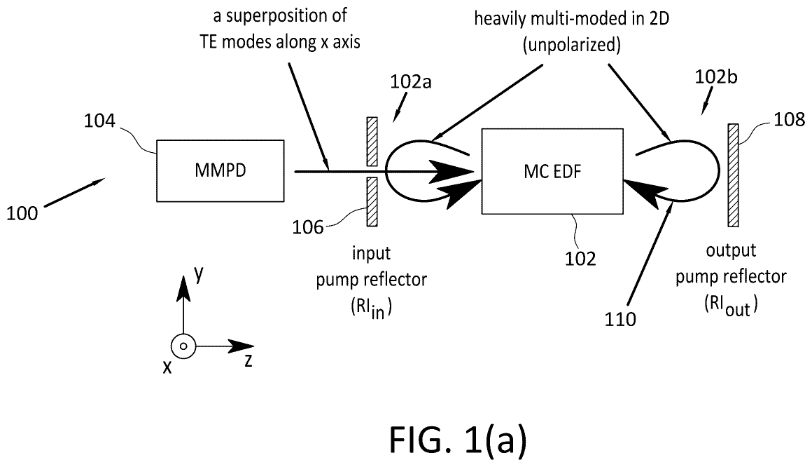

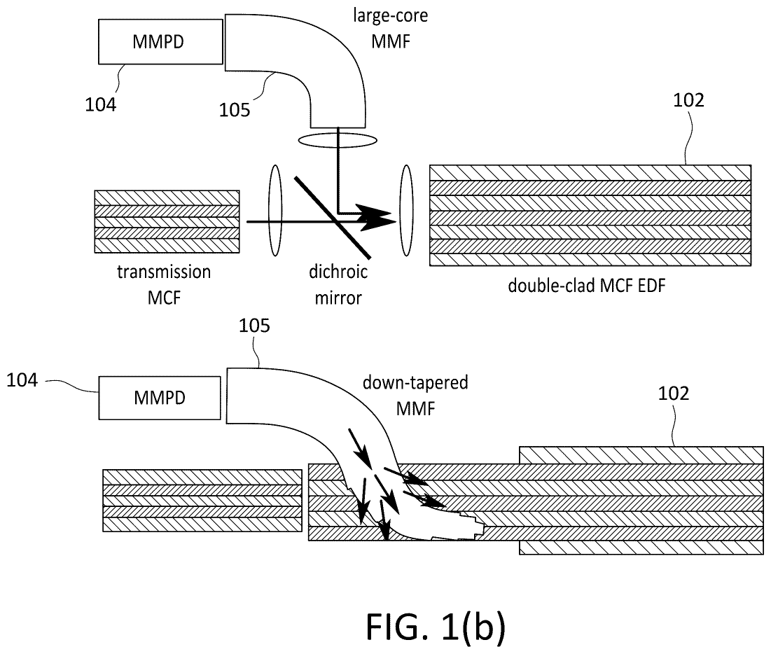

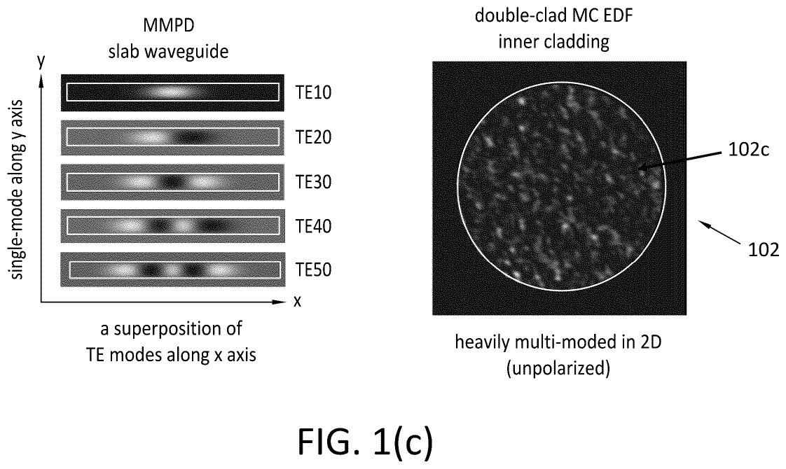

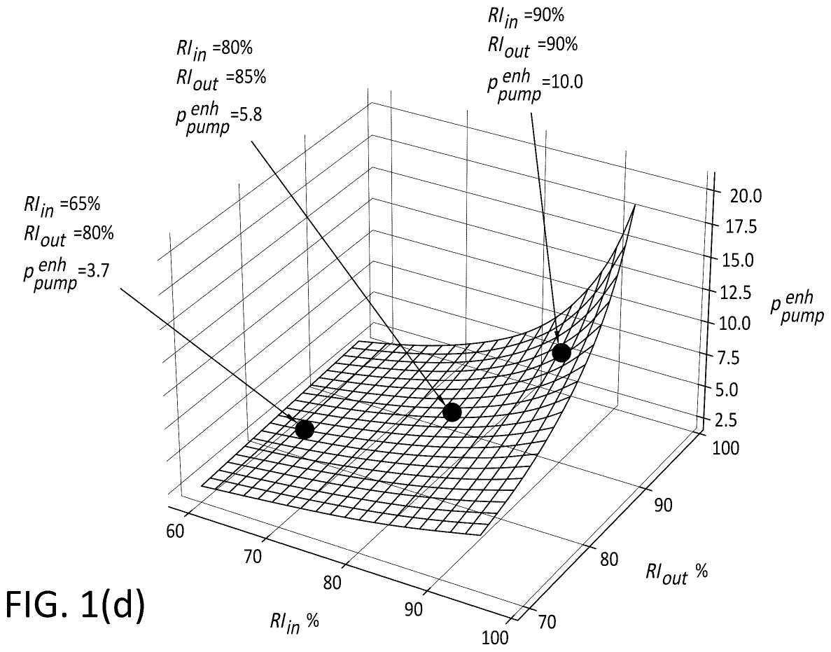

FIG. 1(a) illustrates a cavity-assisted pump recycling system for an MC EDF according to embodiments of the present invention. The system 100 includes a diode 104, such as an MMPD, coupled with the fiber 102, in this case, MC EDF 102. The system 100 also includes a pump reflector 106 at the input end 102a of the fiber 102 and pump reflector 108 at the output end 102b. MC EDF 102 may be configured as a non-resonant cavity by incorporating pump reflectors 106, 108 at both the input end 102a and output end 102b of MC EDF 102.

The MMPD 104 emits light, referred to herein as pump light. The pump light propagates in the Z direction (forward direction). Directions X, Y and Z are orthogonal to each other. The pump light traverses the pump reflector 106, enters the MC EDF 102 at the input end 102a and propagates further in the MC EDF 102 toward the output end 102b.

MMPD 104 could output either pump light that is x- or y-polarized, which is independent of its mode content.

In some embodiments, a half-plate could be placed after the MMPD 104, which can alter the polarization but maintain the mode content.

In some embodiments, the pump reflector 106 is an apertured mirror. The pump light then passes through an aperture of the pump reflector 106. The aperture may be a slot extending mainly in the X direction.

At the output end 102b, the pump reflector 108 can be a simple mirror to reflect and re-inject unused pump light 110 back into the MC EDF 102. The backward-propagating pump light becomes highly multi-moded as it exits through the input. To recycle the pump light at the input end 102a, a two-fold approach may be applied utilizing polarization filtering and spatial filtering.

A polarization beam splitter (PBS) can be applied as a polarization-dependent optical circulator. This setup transmits the TE modes from the MMPD 104 while reinjecting the Y-polarized backward-propagating pump light, carrying half of the power, back into the MC EDF 102 via a dielectric mirror. With spatial filtering, the X-polarized pump light can be recycled by exploiting the single-mode property of the MMPD 104 slab modes in the Y-direction. This can be achieved through an apertured mirror with a narrow pass-through slot.

According to embodiments of the present invention, side or edge coupling can be employed to pump light from a diode into the core and cladding regions of the doped fiber, such as an MC EDF. FIG. 1(b) shows a 980-nm pump delivery schemes applied in cladding-pumped MC EDFAs (top) side and (bottom) edge coupling. As shown, a pump diode such as an MMPD 104 can be coupled using a large-core or downwardly tapered MMF 105 for coupling. See [2] and [6].

According to embodiments of the invention, as shown in FIG. 1(a), the MMF can be omitted to preserve the few-mode and single-polarization properties of the MMPD 104 before coupling into the MC EDF 102. Thus, the MMPD 104 may be directly coupled with the MC EDF 102.

Although a single-mode pump diode could be used, an MMPD is preferred for its additional power and modes. An MMPD can emit single-polarization modes (TE modes), and operate with several stable lasing modes that are few-moded. [11]. However, more than 2000 linearly polarized (LP) modes at 980 nm are supported by pump delivery MMF with a cladding diameter of 100 μm. This randomly scrambles the modes from the MMPD, causing the system to lose both the pump's mode polarization and its few-mode characteristics.

FIG. 1(c) illustrates the modal composition of input and recycled pump lights. On the left hand side, modes of multi-mode pump light from a MMPD are shown including TE10-TE50, which are primarily X-direction modes of light. On the right hand side, it can be clearly seen that the recycled light is heavily multi-moded and unpolarized, spatially dispersed within the entire inner cladding 102c (including the cores) of a double clad fiber 102.

FIG. 1(d) illustrates the pump power enhancement, p^{enh}ₚᵤₘₚ, as a function of reinjection efficiencies at both EDF input (RIin) and output (RIout) under the assumption of negligible pump absorption due to minimal core-to-cladding overlap. P^{enh}ₚᵤₘₚ represents the factor by which the pump density is increased within the EDF. As shown, pump density is increased by factors reaching or exceeding 10.

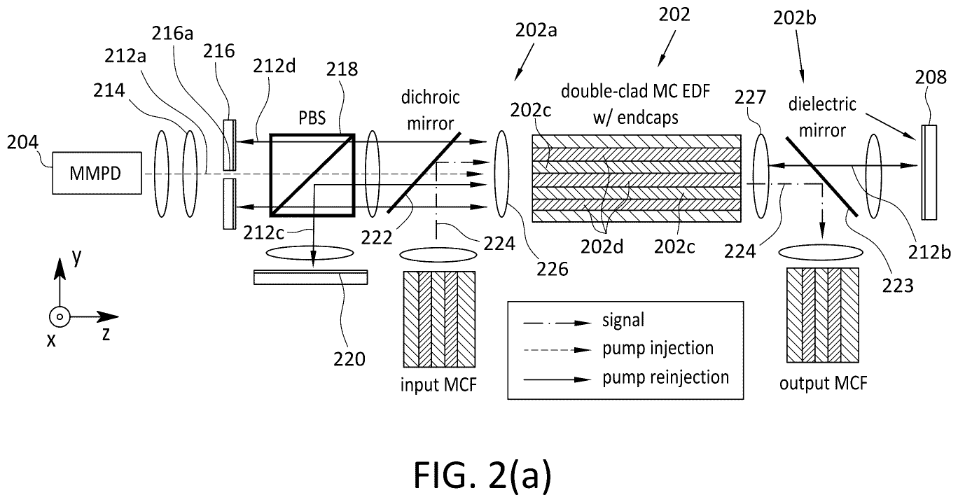

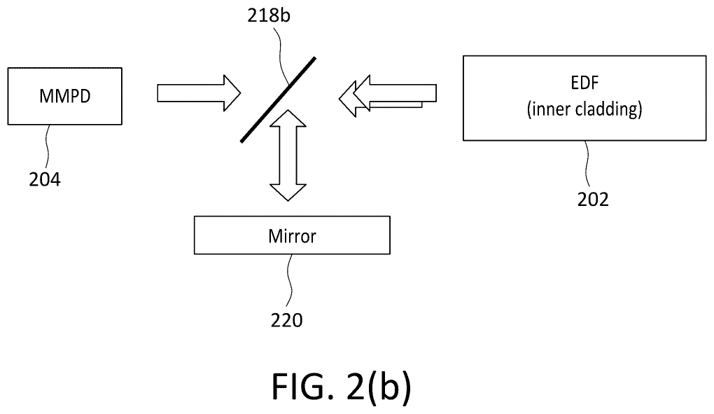

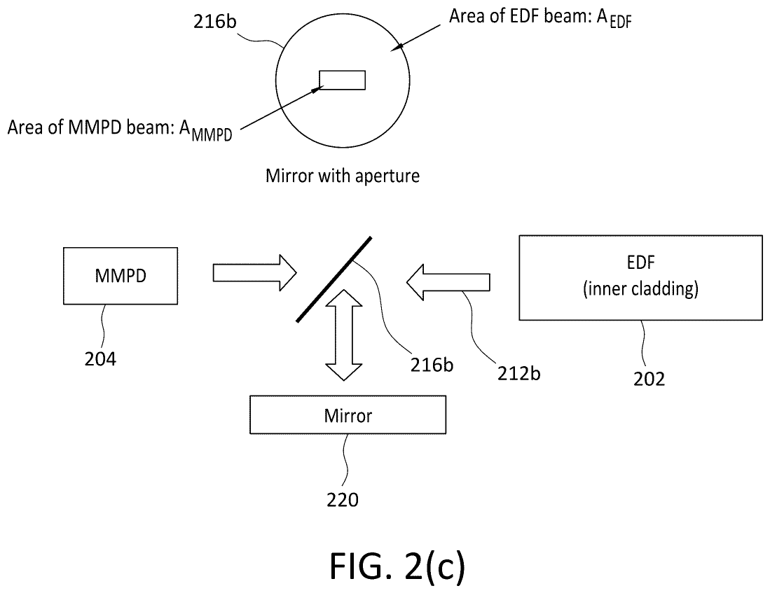

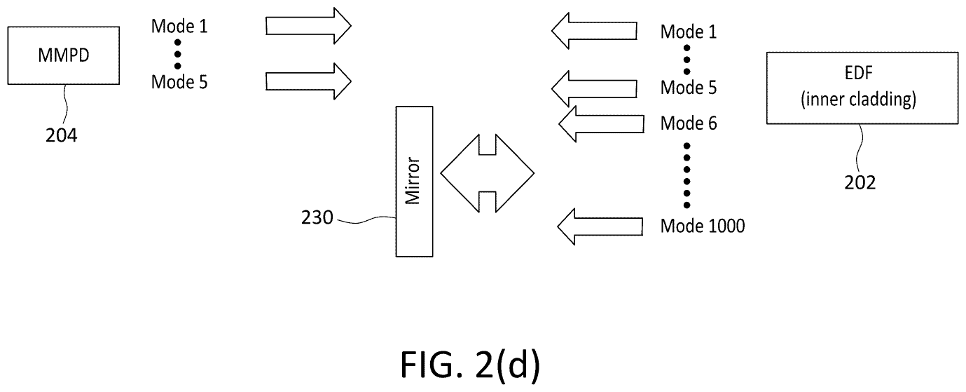

FIG. 2(a) is a schematic diagram of a cladding-pumped MC EDF using the cavity-assisted pump recycling scheme according to embodiments of the present invention.

As shown, an MC EDF 202 has an input end 202a and an output end 202b. An MMPD 204 may emit pump light 212a. The pump light 212a propagates into the cores and the cladding of the MC EDF 202 at the input end 202a. At the output end 202b, a dielectric mirror 208 can be provided to reflect and re-inject unused pump light 222 back into the MC EDF 202.

The skilled person will understand that lenses, filters and/or apertures may be provided to focus and re-focus pump light. As shown, pump light 212a from MMPD 204 travels through lenses 214 to an apertured mirror 216 with a narrow pass-through slot 216a. The lenses focus the light on the thin slot 216a, which creates a thin beam of light in a transverse plane and allows the pump light 212a to pass from the MMPD 204 directly into the fiber, while the surrounding mirror region reflects the remaining (reverse-travelling) pump light effectively. The skilled person will understand the configuration of the lenses and size of the aperture can be used to control the size of the light being injected into the fiber.

A polarization beam splitter (PBS) 218 can be provided as a polarization-dependent optical circulator between the apertured mirror 216 and the input to the MC EDF 202. This setup transmits the TE modes from the MMPD 204 while reinjecting the Y-polarized backward-propagating pump light 212c, carrying half of the power, back into the MC EDF 202 via a dielectric mirror 220, which also allows the signal to be input into the cores of the MC EDF 202.

C-band signal 224 from an input source (input MCF) can be combined with pump light at the input end 202a and separated from the pump light at the output end 102b (and directed to an output MCF) using wavelength selective reflectors, such as dichroic mirrors 222, 223.

As shown, pump light 212a having a first modal composition is injected into the cores and inner cladding of MC EDF 202 on the left side via the aperture 216a, PBS 218 and lenses 226, directly into both the cladding 202c and cores 202d of the MC EDF 202. Dichroic mirror 222 allows signal light 224 to also be injected into the cores 202c of fiber 202. The signal light 224 may carry data. At the output end 202b, the pump light passes through the dichroic mirror 223 and reflects off dielectric mirror 208 as reverse-direction pump light 212b back through the dichroic mirror 223 and a lens 227 back into the cladding and cores of the fiber 202. This pump light 212b has a different modal composition than that of the injected pump light 212a. As shown, pump light 212b passes through the dichroic mirror 222 to the PBS 218, which splits the pump light 212b into Y-polarized backward-propagating pump light 212c and X-polarized backward-propagating pump light 212d, which are in-turn reflected back into the cores and cladding of the fiber 202 by dielectric mirror 220 and apertured mirror 216 respectively.

The size of the reflectors and configuration of the lenses can be adjusted to control the final size of the recycled pump light. It is preferred to have the input light as thin as possible, but the recycled light to have a big overlap between the cores and the cladding within the fiber.

FIG. 2(b) shows an alternative embodiment for the input end of the amplifier using a polarization at the input according to embodiments of the present invention. In this configuration, only polarization filtering is performed at the input end and no aperture is used. The PBS 218b or some other polarization component filters input pump light to a single pole, e.g., x-pole light, which is injected into the EDF. As shown, reflected light reflected pump light is unpolarized, e.g., x-pole and y-pole light. The y-pole light can be split by PBS 218b and reflected with a mirror 220 back into the EDF 202 along with the injected x-pole light from MMPD 204 to generate a pump efficiency up to 50%.

FIG. 2(c) shows an alternative embodiment for the input end of the amplifier using an apertured mirror according to embodiments of the present invention. Spatial filtering is performed using a smaller aperture in a mirror 216. The area of the injected pump light A_{MMPD} is shown as much smaller aperture light than that of the reflected pump light A_{EDF}. Efficiency can be calculated as (A_{EDF}−A_{MMPD})/A_{EDF}. Thus, the ideal efficiency can be more than 90%. That is, more than 90% of the reflected, multi-moded light is directed off the apertured mirror 216 to the mirror 220, back into EDF 202.

FIG. 2(d) shows an alternative embodiment for the input end of the amplifier using a mode filter 230 according to embodiments of the present invention. In this example, the input pump 204 is few-modes (several or tens of modes), e.g. 5 modes. The reflected pump is thousand modes, e.g., 1000 modes. The ideal efficiency is therefore (1000−5)/1000=99.5% Mode selective (de)multiplexers 230 may be employed in this example.

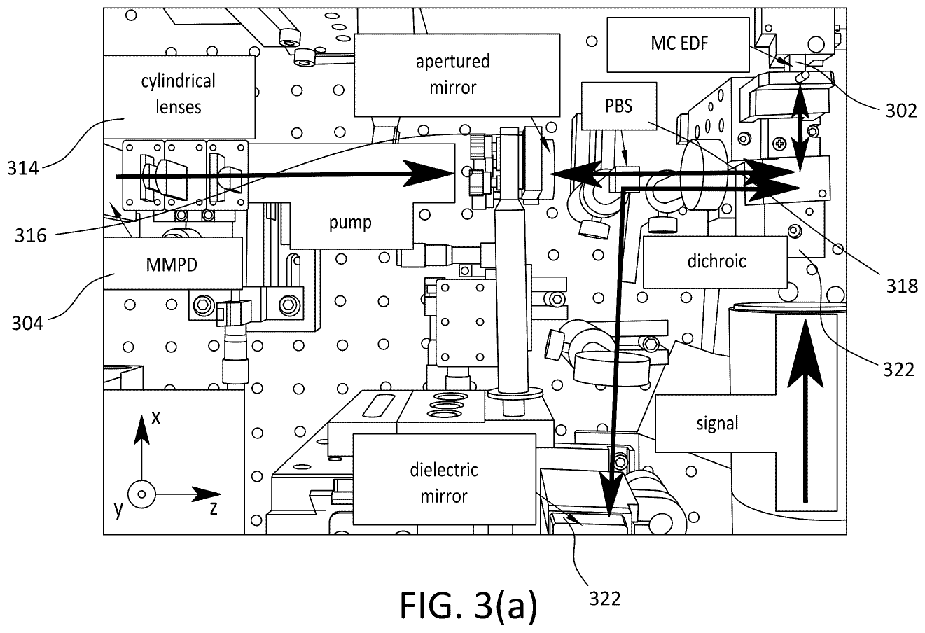

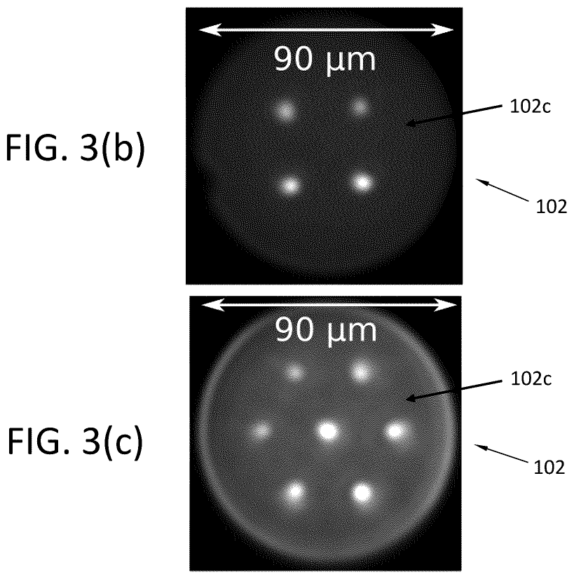

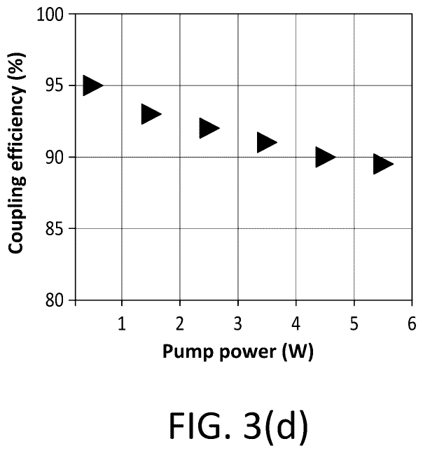

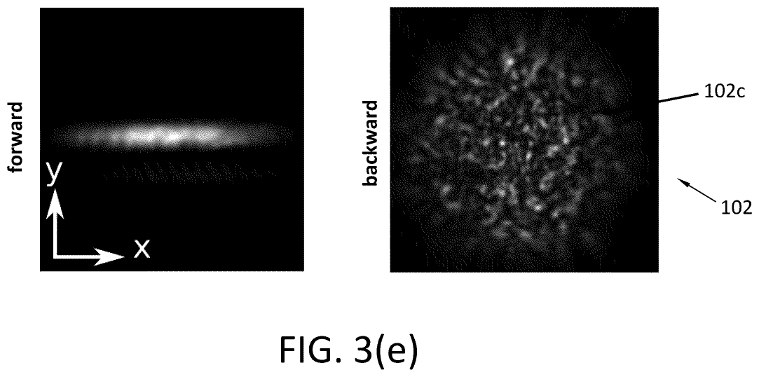

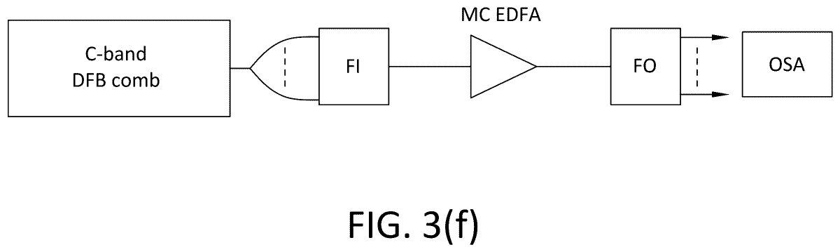

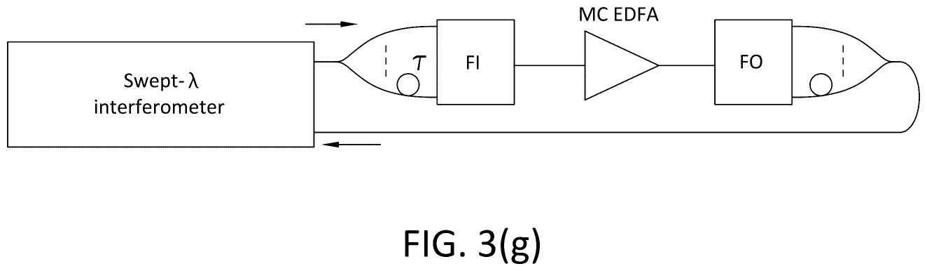

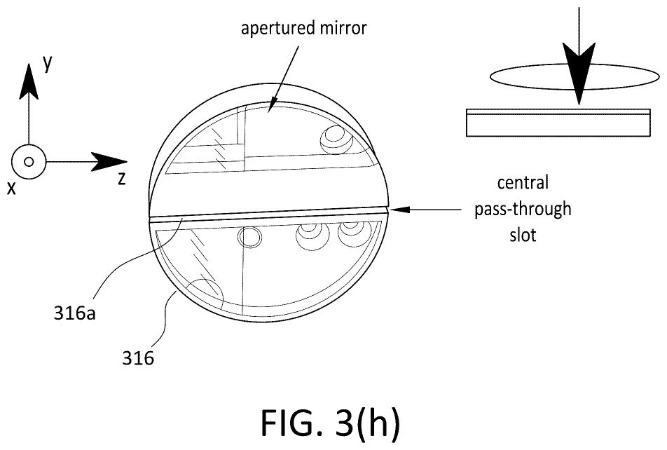

Experiments were performed to demonstrate aspects of the present invention. The experimental setup is shown in FIG. 3(a). A 980-nm MMPD 304 was used in the experiment having a narrow height of 1 μm and width of 100 μm along the X direction. A fast-axis collimator (not shown) was attached to the MMPD 304 to reduce beam divergence at the Y-direction. Cylindrical lenses 314 were applied to demagnify the beam by a factor of 2 along the X-direction. Double-clad MC EDFs 302 with 4-core and 7-core configurations were tested, having a core pitch of 24 μm and 22.7 μm, respectively, as shown in FIG. 3(b) and (c). Both fibers shown in FIG. 3(b) and (c) consist of Er/Al/Ge-doped SiO2 cores, a 90 μm fluorine-doped SiO2 inner cladding and a 154 μm low-index fluoropolymer outer cladding. Measured mode-field diameter of the core is around 5.5 μm at 1550 nm. The EDFs were between 5-10 meters in length with a mirror at the output end of the EDFs (not shown).

An apertured mirror 316 (image in FIG. 3(h)), in this case, a d-shift mirror with a small slot in the mirror, was coupled with the MMPD 304, a PBS 318, dielectric mirror 320 and the dichroic mirror 322 at the (signal) input to MC EDF 302. Lenses 314 were 4f. A dielectric mirror (not shown) was provided at the output end of the MC EDF 302.

FIG. 3(d) is a graph of measured pump coupling efficiency between the MMPD and the double-clad MC EDF with an inner cladding diameter of 90 μm according to embodiments of the present invention. As shown, coupling efficiency was measured at 95% with a pump power below a single watt.

Measured pump coupling efficiency between the MMPD and the MC-EDF exceeded 90%, see FIG. 3(d), excluding a 4% facet Fresnel reflection loss that can be mitigated with anti-reflection (AR) coating. The efficiency slightly decreased at higher MMPD output powers due to the increased presence of higher-order modes, which are more susceptible to free-space aberrations. The measured reinjection efficiency at the output RIout is around 80%, which can be further improved using better imaging optics. FIG. 3(d) shows the image of the free space setup for pump (re)injection at input end.

FIG. 3(e) provides the images for forward-propagation pump light from the MMPD and backward-propagation pump light from the EDF at the apertured mirror, which consists of two D-shaped mirrors. The forward-propagating pump has a measured beam waist around 80 μm along the Y-direction, while the backward-propagating pump has a beam diameter around 2 mm. The overlap between the forward and backward beams is less than 10%, indicating that over 90% of the pump power can be collected using a precisely apertured mirror. The pump reinjection efficiency at input is contributed by both spatial and polarization filtering, which is measured around 25% and 40%, respectively, resulting in a total RIin around 65%. Combined with an RIout of 80%, this enables a pump power enhancement p^{enh}ₚᵤₘₚ around 3.7.

Referring to FIG. 3(f) and 3(g), 10 distributed-feedback lasers (DFBs) with wavelengths equally spaced over the C-band, along with low-loss MCF fan-in (FI) and fan-out (FO) devices and an optical spectrum analyzer (OSA), were used to characterize the gain and noise figure (NF) of both 4-core and 7-core EDFAs. Total input power per core is set to −9 dBm. Insertion losses from the FI/FO are excluded from the calculations. A polarization-diversity swept wavelength interferometer [13] is used to characterize the mode-dependent loss (MDL) of the MC EDFAs.

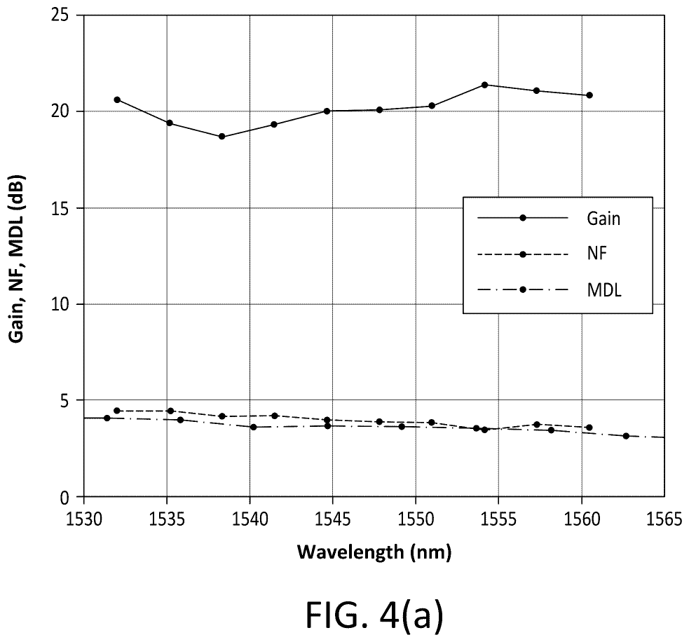

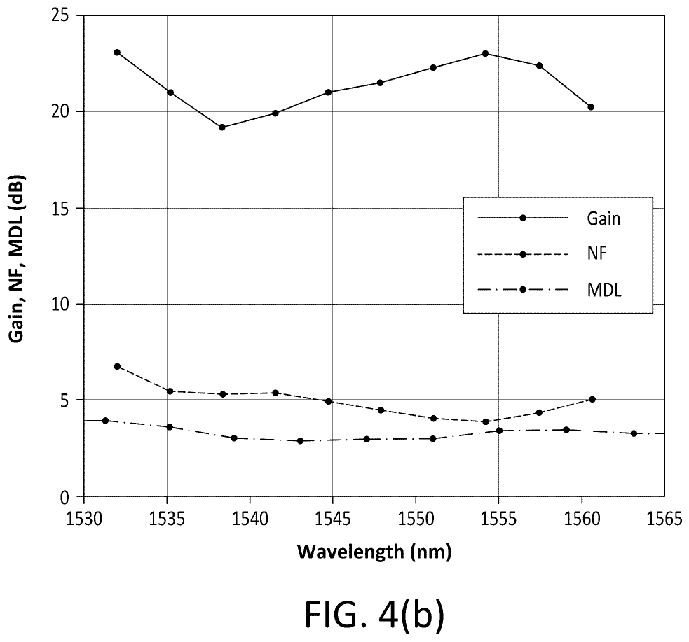

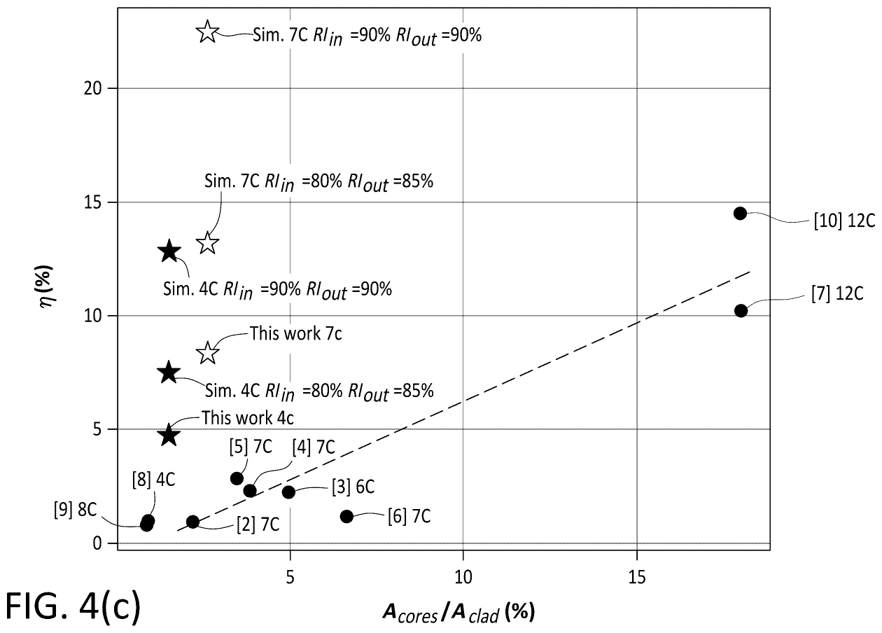

The measured average gain, NF and MDL results over the C-band, under the pump power of 1.1 W, are provided in FIG. 4(a) and 4(b) for the 4-core and 7-core EDFAs, respectively. This work achieved record power conversion efficiency η of approximately 5% and 8% for the 4-core and 7-core EDFAs, respectively, in cases where core-to-cladding area overlap is less than 2.5%, as summarized in FIG. 4(c). Simulations indicate that the η of the 7-core EDFA could surpass 20%, comparable to that of single-mode EDFAs, with further improvements in reinjection efficiency approaching 90%.

Although specific embodiments of the invention have been described and illustrated, the invention is not to be limited to the specific forms or arrangements of parts so described and illustrated. The scope of the invention is to be defined by the claims appended hereto and their equivalents.

### LIST OF ABBREVIATIONS

The following abbreviations were used herein and are given the following meanings:
SDM—Space division multiplexing
MCF—multi-core fiber
MC EDFA—multi-core erbium-doped fiber amplifier
EDFA—erbium-doped fiber amplifier
MMPD—multi-mode pump diode
DFB—distributed-feedback laser
FI—fan-in
FO—fan-out
OSA—optical spectrum analyzer
DFB—distributed-feedback laser
PBS—polarization beam splitter

In this description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Bracketed numerals [#] used above refer to the following publications, the contents of which are hereby incorporated by reference herein.
1. B. Quigley and M. Cantono, Blog: “Boosting Subsea Cables with Multi-Core Fiber Technology”
2. K.S. Abedin et al., “Seven-core erbium-doped double-clad fiber amplifier pumped simultaneously by . . . ”, OL, 39(4), 993-996, 2014.
3. H. Chen et al., “Demonstration of cladding-pumped six-core erbium-doped fiber amplifier”, JLT, 34(8), 1654-1660, 2016.
4. K. Maeda et al., “Cladding pump recycling using cascaded pump collectors in 7-core EDFA”, Proc. ECOC 2019, pp. 1-4
5. S. Takasaka et al., “Output power increase of cladding pumped 7-core EDFA by using mie scattering”, Proc. ECOC 2020, pp. 1-4
6. H. Takeshita et al., “Configurations of Pump Injection and Reinjection for Improved Amplification . . . ”, JLT, 38(11), 2922-2929, 2020.
7. M. Wada et al., “Full C-band and power efficient coupled-multi-core fiber amplifier”, Proc. OFC 2020, pp. M4C.3
8. Z. Gu et al., “High-efficiency cladding-pumped 4-core erbium-doped fiber with a pedestal . . . ”, OE, 30(10), 34973-34983, 2022.
9. C. Matte-Breton et al., “Large area Bragg grating for pump recycling in cladding-pumped . . . ”, OE, 30(11), 17824-17835, 2022.
10. T. Sakamoto et al., “Coupled 12-core fibre amplifier with efficiency improved by cladding . . . ”, Proc. ECOC 2023, pp. 182-185
11. P. Crump et al., “Experimental and theoretical analysis of the dominant lateral . . . ” , Semicond. Sci. Technol., 27(4), 045001, 2012.
12. V.I. Kopp et al., “Ultra-Low-Loss MCF Fanouts for Submarine SDM Applications”, Proc. OFC, 2022, paper Th1E-2.
13. N.K. Fontaine et al., “Characterization of space-division multiplexing fibers using swept-wavelength . . . ”, Proc. OFC 2015, pp. 1-3.

We claim:

1. An amplifier for amplifying signals in a multi-core doped fiber, the multi-core doped fiber having a plurality of cores encapsulated by a cladding, an input end and an output end, comprising:
a pump diode optically coupled with the input end of the fiber, said pump diode adapted to generate pump light having a first modal composition;
a first reflector positioned at the output end adapted to reflect pump light back onto the fiber as reflected pump light having a second modal composition;
a filter positioned at the input end adapted to alter the reflected pump light into a third modal composition; and
at least one second reflector positioned at the input end adapted to reinject the altered pump light back into the fiber at the input end.

2. The amplifier of claim 1, wherein said first modal composition represents a thin line of light in a transverse plane.

3. The amplifier of claim 1, wherein first modal composition is single pole light and the second modal composition is multi-pole light.

4. The amplifier of claim 1, wherein said first modal composition is few-mode light and the second modal composition is hundred-mode or higher light.

5. The amplifier of claim 1, wherein said first modal composition is small-aperture light and the second modal composition is big-aperture light.

6. The amplifier according to any of the preceding claims, further comprising an aperture positioned at said input end between said diode and said fiber adapted to pass pump light from said diode into said fiber.

7. The amplifier according to any of the preceding claims, wherein said diode is a multi-modal pump diode.

8. The amplifier according to any of the preceding claims, wherein said filter includes a polarizing beam splitter adapted to split the reflected pump light into at least two directions, and said at least one second reflector is adapted to reflect the light in said at least two directions back into said fiber.

9. The amplifier according to any of the preceding claims, wherein said amplifier is adapted to inject said pump light into both the cores and the cladding of said fiber.

10. The amplifier according to any of the preceding claims, further comprising:
a polarization beam splitter positioned between the diode and the input end of said fiber and adapted to allow transmission of TE modes of the pump light into the cores and cladding of the fiber and for splitting the reflected pump light having a second modal composition into X-polarized light and Y-polarized light; and
said at least one second reflector including a first mirror for reflecting the X-polarized light and a second mirror for reflecting the Y-polarized light.

11. The amplifier according to any of the preceding claims, further comprising an apertured mirror having a narrow pass-through slot adapted to allow TE modes of the pump light from the diode to pass through the slot into the cladding and cores of the fiber and for reflecting X-polarized backward-propagating pump light into the cladding.

12. The amplifier according to any of the preceding claims, further comprising first and second selective wavelength reflectors for combining signal light with pump light at the input end and separating the signal light from pump light at the output end.

13. The amplifier according to any of the preceding claims, wherein a pump power within the fiber is amplified by a factor of at least 3.

14. The method according to any of the preceding claims, wherein a pump power within the fiber is amplified by a factor of at least 10.

15. A method for amplifying signals in a multi-core doped fiber, the multi-core doped fiber having a plurality of cores encapsulated by a cladding, an input end and an output end, said method comprising steps of:
injecting pump light having a first modal composition into the input end of the fiber;
reflecting the pump light at the output end back onto the fiber as reflected pump light having a second modal composition;
filtering the reflected pump light at the input end to have a third modal composition; and
reinjecting the reshaped pump light back into the fiber at the input end.

16. The method of claim 15, wherein said first modal composition is a thin line in a transverse plane.

17. The method of claim 15, wherein said first modal composition is single pole light and the second modal composition is multi-pole light.

18. The method of claim 15, wherein said first modal composition is a few-mode light and the second modal composition is hundred-mode or higher light.

19. The method of claim 15, wherein said first modal composition is small-aperture light and the second modal composition is big-aperture light.

20. The method according to any of the preceding claims, wherein said injecting step includes filtering the pump light with an aperture and/or a polarization beam splitter.

21. The method according to any of the preceding claims, wherein said injecting step includes generating the pump light with multi-modal pump diode.

22. The method according to any of the preceding claims, wherein said filtering step includes splitting the reflected pump light with a polarizing beam splitter into at least two directions, and light in said at least two directions is reflected back into said fiber.

23. The method according to any of the preceding claims, wherein said injecting step injects said pump light into both the cores and the cladding of said fiber.

24. The method according to any of the preceding claims, wherein said injecting step includes using a polarization beam splitter to transmit TE modes of the pump light into the cores and cladding of the fiber and said reinjecting step includes reinjecting Y-polarized reflected pump light into the cores and cladding of the fiber.

25. The method according to any of the preceding claims, wherein said injecting step includes using an apertured mirror having a narrow pass-through slot to allow TE modes of the pump light from the MMPD to pass through the slot into the cladding while reflecting X-polarized backward-propagating pump light into the cladding.

26. The method according to any of the preceding claims, further comprising a step of combining signal light with the pump light at the input end and separating the signal light from the pump light at the output end.

27. The method according to any of the preceding claims, wherein a pump power within the fiber is amplified by at least a factor of at least 3.

28. The method according to any of the preceding claims, wherein a pump power within the fiber is amplified by at least a factor of at least 10.
